(19) United States
(12) Patent Application Publication
(10) Pub. No.: US 2026/0257899 A1
(43) Pub. Date: Sep. 3, 2026

(54) AUTONOMOUS FORKLIFT TRUCK FOR TRANSPORTING LOADS, AND ASSOCIATED METHOD

(71) Applicant: COMPAGNIE GENERALE DES ETABLISSEMENTS MICHELIN, Clermont-Ferrand (FR)

(72) Inventors: YANN BINDA, Clermont-Ferrand (FR); FLORIAN FAURE, Clermont-Ferrand (FR); KEVIN BOUVET, Clermont-Ferrand (FR)

(21) Appl. No.: 18/876,116

(22) PCT Filed: Jun. 14, 2023
(86) PCT No.: PCT/FR2023/050866

§ 371 Date: Dec. 17, 2024

(30) Foreign Application Priority Data
Jun. 22, 2022 (FR) FR2206208

(51) Int. Cl. B66F 9/06; B66F 9/075

(52) U.S. Cl. CPC B66F 9/063; B66F 9/0755

(57) ABSTRACT

This autonomous forklift truck (1) comprises: a vertically movable fork (4) that is provided with at least two arms (4a, 4b) for lifting loads, a drive system (7), and a control unit that is able to actuate the operation of the drive system (7) in order to autonomously guide the forklift truck, and that is able to actuate the vertical movement of the fork. The truck also comprises a contactless load detection device (10) that is movable together with the fork (4) and is disposed above the arms (4a, 4b) of the fork. The detection device (10) is able to emit a light beam that sweeps over at least one predefined planar detection zone situated above the arms (4a, 4b) in order to detect a load. The truck also comprises a means for determining a movement of the truck.

### TECHNICAL FIELD

The present invention relates to the field of autonomous vehicles for the automated transport of loads, such as autonomous forklift trucks.

### PRIOR ART

Autonomous vehicles for transporting loads are being increasingly used to increase productivity and improve logistics management in factories or in warehouses.

Automated forklift trucks are an example of such vehicles and make it possible, for example, to load and transport a load and position it at height without human intervention.

However, in environments such as factories or warehouses, human intervention remains necessary in addition to the automated operations, for example in order to check that these operations are taking place properly or to carry out tasks that cannot be carried by machines alone. These environments are thus shared by humans and autonomous machines.

The safety of personnel is fundamental in such work environments and consequently requires the implementation of specific procedures.

For example, in order to limit the risk of the transported loads being dropped, the forklift trucks are conventionally provided with mechanical sensors disposed on the vertical uprights of the fork used for lifting, transporting and setting down these loads.

Such mechanical sensors are in the form of stops that pivot between an extended position corresponding to a load that is absent or not in contact with said stop, and a retracted position corresponding to a load in contact with said stop.

However, these mechanical sensors installed at the bottom of the carriage do not make it possible to ensure, during the setting down of a load, that the deposition on the storage rack has been carried out correctly, or to ensure, during the picking up of a load from the rack, that this picking up has also been carried out correctly.

This entails a risk of accidents.

Specifically, following the setting down of the load on a rack, if the arms of the fork are not withdrawn correctly with respect to the pallet carrying this load and remain in contact therewith, there is a significant risk of the load dropping during the reversing of the truck.

This risk of dropping also exists during the picking up of a load from a rack if the arms of the fork of the truck are not positioned correctly with respect to the load, and so the load can be pushed off the rack when the truck advances.

### DISCLOSURE OF THE INVENTION

In the light of the above, the aim of the invention is therefore to propose an autonomous forklift truck that is capable of increasing the reliability and safety of the operations of setting down and picking up a load from a storage rack.

A subject of the invention is an autonomous forklift truck comprising a vertically movable fork that is provided with at least two arms for lifting loads, a drive system for moving the forklift truck, and a control unit that is able to actuate the operation of the drive system in order to autonomously guide the forklift truck and that is able to actuate the vertical movement of the fork.

According to a general feature, the forklift truck also comprises a contactless load detection device, said detection device being movable together with the fork and being disposed above the arms of said fork. The contactless detection device is able to emit a light beam that sweeps over at least one predefined planar detection zone situated above the arms in order to detect the presence or the absence of a load.

According to another general feature, the forklift truck also comprises a means for determining a movement of the forklift truck. The determining means is able to acquire information representative of the movement of the forklift truck from a position of the forklift truck in which it is setting down or picking up a load, said position being saved by the control unit.

According to another general feature, the control unit receives representative information output by the determining means and information representative of the presence or the absence of the load in said predefined planar detection zone that is output by the contactless detection device.

According to another general feature, the control unit is able to actuate the operation of the drive system and the vertical movement of the fork on the basis of this information.

With such an autonomous forklift truck, it is now possible to ensure, following the setting down of a load on a storage rack, that the vehicle is reversed without any risk of the set-down load dropping.

It is now also possible to ensure, during the picking up of a load from a storage rack, that the vehicle is advanced without any risk of the load being pushed and thus dropping.

Moreover, the incorporation of such a contactless detection device makes it possible to carry out remote detection of any type of loads.

Advantageously, the determining means comprises at least one rotary encoder that is able to measure the rotation of at least one wheel of the forklift truck.

The incorporation of such a rotary encoder promotes the achievement of highly precise control of the movement of the truck.

Advantageously, said predefined planar detection zone that is swept by the light beam emitted by the contactless detection device is horizontal.

Preferably, said predefined planar detection zone that is swept by the light beam emitted by the contactless detection device is situated above the two arms. In this case, said planar detection zone can extend laterally at least partially beyond the transverse space requirement of said arms of the fork.

In a variant, the contactless detection device can sweep two separate planar detection zones, namely a first predefined planar detection zone situated above a first arm of the fork and a second predefined planar detection zone situated above a second arm of the fork that is different from the first arm.

According to another feature, the fork comprises at least two uprights supporting the arms, the contactless detection device being disposed on one of the uprights.

The autonomous forklift truck comprises an onboard locating device configured to acquire forklift-truck position data and communicating with the control unit. Preferably, the contactless detection device is separate from the locating device.

Preferably, the determining means is separate from the locating device. Alternatively, however, it could be conceivable for the locating device to form the determining means.

In one particular embodiment, the automatically guided forklift truck may also comprise a stop disposed on each of the uprights of the fork and mounted so as to pivot between an extended position corresponding to a load that is absent or not in contact with said stop, and a retracted position corresponding to a load in contact with said stop, the contactless detection device disposed on said upright being situated above the associated stop. Alternatively, it remains possible for the truck not to be equipped with these stops.

According to another aspect, a subject of the invention is a method for transporting and setting down a load using an autonomous forklift truck as described above.

The method for transporting and setting down comprises:
a step of setting down the load, in which the forklift truck has reached a position for setting down the load,
a step of recording the position of the forklift truck in said position for setting down the load as a reference position,
a step of load detection by the contactless detection device in at least one predefined planar detection zone,
if the load is not detected in the detection step, a step of reversing the forklift truck by a predetermined reversing distance which is controlled via the information output by the determining means,
following the step of reversing the forklift truck by the predetermined reversing distance, a step of load detection by the contactless detection device in at least one predefined planar detection zone which is contiguous with said preceding planar detection zone, which is situated on the opposite side to the contactless detection device with respect to said preceding planar detection zone, and which has a lateral dimension equal to the value of reversing the forklift truck carried out in the reversing step,
if the load is not detected in the immediately preceding detection step, repeating the reversing step and the detection step until a load is detected in at least one predefined planar clearance zone with respect to the free end of the arms of the fork, and
a step of moving the forklift truck, which is triggered at least on the basis of the presence or absence of a load in said predefined planar clearance zone.

With this method for setting down, safety is improved by making it possible to check, during the setting down of the load on a storage rack, that this load remains in position on the rack and is not carried along by the truck while it is reversed.

For example, the predefined planar clearance zone may be situated in front of the free end of the arms of the fork.

Alternatively, the predefined planar clearance zone may be situated behind the free end of the arms of the fork, and the step of moving the forklift truck is triggered if the absence of a load in said clearance zone is detected and if the sum of the values of reversing the forklift truck carried out from the setting down position is greater than the distance between the free end of the arms of the fork and the part of said detection zone in the step which is situated next to the detection device.

Advantageously, the reversing of the forklift truck that is carried out during the reversing steps has a constant value. Alternatively, it remains possible to provide variable reversing values.

In one particular embodiment, the steps of reversing the forklift truck are carried out continuously without stopping, said detection zones and said clearance zone being activated by the detection device successively according to the constant reversing value of the forklift truck.

In another embodiment, it could be possible for the steps of reversing the forklift truck to be carried out incrementally with a stopping phase between two successive reversals.

A further subject of the invention is a method for lifting and transporting a load using an autonomous forklift truck as described above.

The method for lifting and transporting comprises:
a step of positioning the arms of the fork with respect to the load to be lifted in a position for picking up the load,
a step of load detection by the contactless detection device in at least one predefined planar detection zone with respect to the free end of the arms of the fork,
if the load is detected in the detection step, a step of recording the position of the forklift truck in said position for detecting the load as a reference position,
a step of advancing the forklift truck by a predetermined advancing distance which is controlled via the information output by the determining means,
following the step of advancing the forklift truck by the predetermined advancing distance, a step of detecting the load by the contactless detection device in at least one predefined planar detection zone which is contiguous with said preceding planar detection zone, which is situated next to the contactless detection device with respect to said preceding planar detection zone, and which has a lateral dimension equal to the value of advancing the forklift truck carried out in the advancing step,
if the load is detected in the preceding detection step, repeating the advancing step and the detection step until a load is detected in at least one predefined planar pick-up zone,
a step of lifting the load if the load is detected in said predefined planar pick-up zone, and
after the lifting step, a step of moving the forklift truck and transporting the load.

With this method for lifting, safety is improved by making it possible to check, during the picking up of the load from a storage rack, that this load remains in position on the rack and is not pushed by the truck while it advances.

Preferably, the advancing of the forklift truck that is carried out during the advancing steps has a constant value. Alternatively, it remains possible to provide variable advancing values.

In one particular embodiment, the steps of advancing the forklift truck are carried out continuously without stopping, said detection zones and said pick-up zone being activated by the detection device successively according to the constant advancing value of the forklift truck.

In another embodiment, it could be possible for the steps of advancing the forklift truck to be carried out incrementally with a stopping phase between two successive advances.

According to one feature, the predefined planar detection zone is defined by four points that delimit a rectangle.

In one embodiment, said step of detecting the load is carried out in a planar detection zone which is common to the arms of the fork.

In another embodiment, said step of detecting the load is carried out in two separate planar detection zones which each belong to one of the two arms of the fork.

### BRIEF DESCRIPTION OF THE DRAWINGS

Further aims, features and advantages of the invention will become apparent on reading the following description given solely by way of non-limiting example and with reference to the appended drawings in which:

FIG. 1 is a perspective view of an autonomous forklift truck according to one exemplary embodiment of the invention;

FIG. 2 schematically illustrates the forklift truck from FIG. 1 while it is being used;

FIG. 3 is a partial top view of the forklift truck from FIG. 1, in which a first load detection zone is schematically shown;

FIG. 4 illustrates the flow chart of a method for transporting and setting down a load according to one embodiment of the invention;

FIG. 5 is a partial top view of the forklift truck from FIG. 1, in which a load detection zone that is contiguous with the preceding load detection zone illustrated in FIG. 3 is schematically shown;

FIG. 6A FIG. 6B FIG. 6C FIG. 6D FIG. 6E FIG. 6F FIG. 6G are partial top views of the forklift truck from FIG. 1, in which successive and contiguous load detection zones that are used in the method illustrated in FIG. 4 are schematically shown;

FIG. 6H is a partial top view of the forklift truck from FIG. 1, in which a clearance zone that is used in the method illustrated in FIG. 4 is schematically shown;

FIG. 7 illustrates the flow chart of a method for lifting and transporting a load according to one embodiment of the invention; and

FIG. 8A FIG. 8B FIG. 8C FIG. 8D FIG. 8E FIG. 8F FIG. 8G FIG. 8H FIG. 8I are partial top views of the forklift truck from FIG. 1, in which successive and contiguous load detection zones that are used in the method illustrated in FIG. 7 are schematically shown; and

FIG. 8J is a partial top view of the forklift truck from FIG. 1, in which a load pick-up zone that is used in the method illustrated in FIG. 7 is schematically shown.

### DETAILED DESCRIPTION OF AT LEAST ONE EMBODIMENT

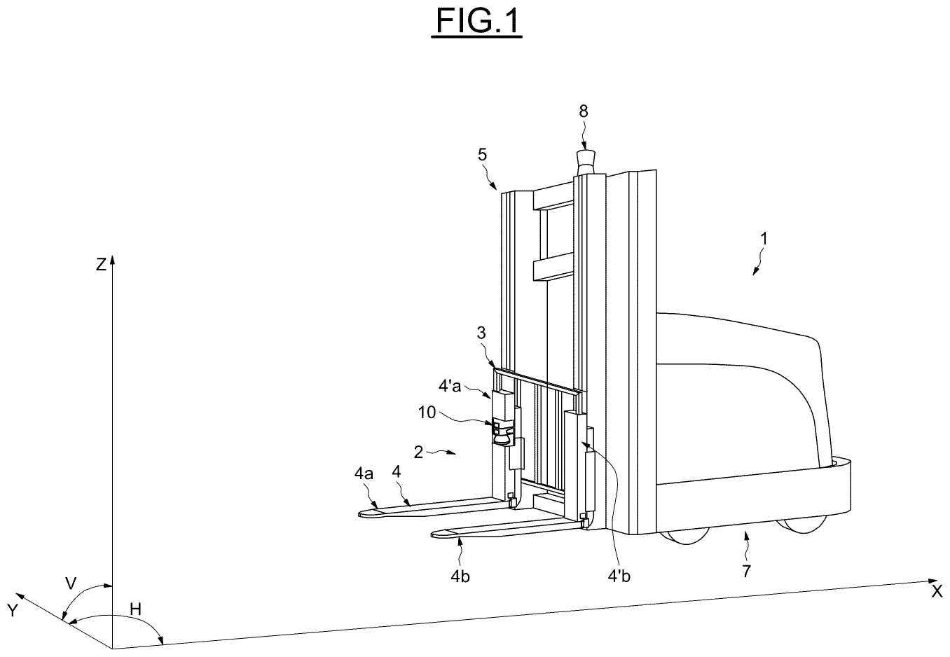

FIG. 1 shows the main elements of an autonomous forklift truck 1 according to one embodiment of the invention.

The architecture of the forklift truck 1 is given by way of example and does not limit the invention just to the configuration of the architecture that is presented. It will be understood that the invention also relates to forklift trucks that are intended to operate in a manual mode and which have been designed to allow a second, autonomous operating mode.

The autonomous forklift truck 1 illustrated in FIG. 1 comprises a fork carriage 3 provided with a fork 4 comprising two arms 4a, 4b that are spaced apart laterally and extend towards the front. The fork 4 also comprises two uprights 4′a, 4′b that each support one of the arms 4a, 4b.

The arms 4a, 4b of the fork are generally used for insertion into insertion tunnels provided in the transport pallets supporting the loads to be raised. The uprights 4′a, 4′b make it possible to raise the arms 4a, 4b in order for it to be possible to raise a pallet to be transported or some other type of load and for it to be possible to place or catch hold of a pallet or some other type of load at height.

The fork 4 is able to move in translation in a vertical plane V defined by the fork carriage 3, along a vertical mast 5 of the truck. The uprights 4′a, 4′b can slide along the mast 5. The longitudinal axes of the arms 4a, 4b of the fork 4 are parallel. These longitudinal axes are oriented parallel to a horizontal axis X, and define a horizontal plane H referred to as the lifting plane. The arms 4a, 4b of the fork 4 are perpendicular to the vertical plane V. The arms 4a, 4b of the fork are also preferably movable laterally with respect to one another.

In a variant, the arms of the fork 4 could be telescopic or retractable, and/or able to be oriented angularly about their longitudinal axis.

In a manner known per se, the truck 1 is equipped with a drive system 7 for moving the truck 1. The drive system comprises at least one electric motor or heat engine (not shown) for driving the wheels 18 of the truck 1.

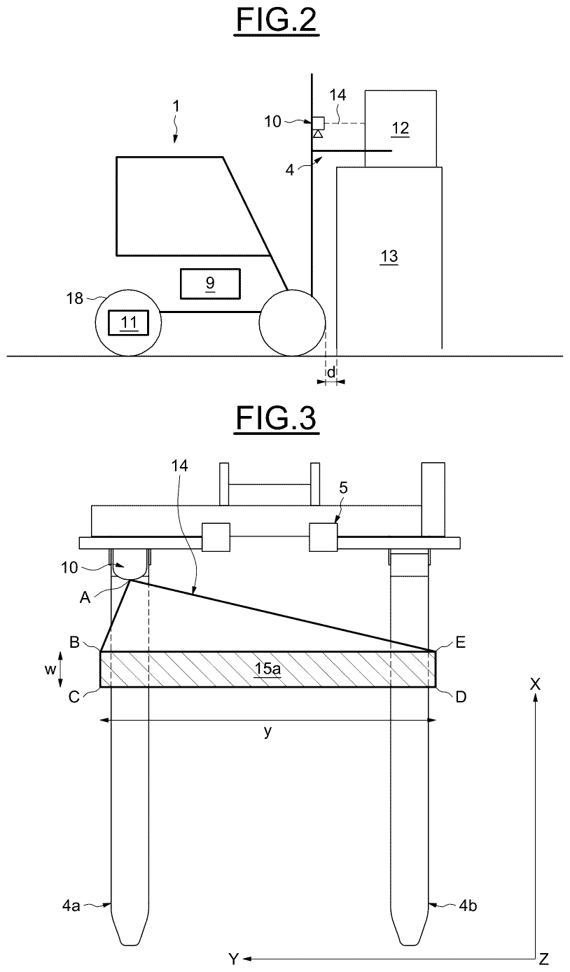

The truck 1 is also equipped with an onboard locating device 8, and with an onboard control unit 9 (FIG. 2) that receives the information output by the locating device 8 in order to autonomously actuate the movement of the forklift truck.

The control unit 9 comprises the hardware and software for actuating the operation of the drive system 7 on the basis of the information received from the locating device 8. The control unit 9 also makes it possible to actuate the autonomous movement of the fork 4.

The truck 1 is also equipped with a means 11 for determining a movement of the forklift truck 1, said determining means 11 being configured to acquire information representative of the movement of the truck 1 and to transmit it to the control unit 9. In a preferred embodiment, the determining means 11 comprises at least one rotary encoder that is able to measure the rotation of at least one wheel 18 of the forklift truck 1. The encoder is able to determine the value of the movement of the forklift truck 1 on the basis of the detected number of rotations of the associated wheel 18.

The truck 1 is also equipped with a contactless detection device 10 which is disposed above the arms 4a, 4b of the fork 4. The detection device 10 is secured to the upright 4′a of the fork and is situated above the arms 4a, 4b. The contactless detection device 10 is movable together with the upright 4′a of the fork. The detection device 10 is separate from the locating device 8 and from the determining means 11.

As will be described in more detail below, the detection device 10 is able to emit a light beam that sweeps over at least one predefined planar detection zone situated above the arms 4a, 4b in order to detect the presence of a load to be lifted via the intersection of the light beam with said load within said predefined planar detection zone.

The detection device 10 is configured to acquire position data of the load to be lifted, and to transmit to the control unit 9 information representative of the presence or the absence of the detected load within the predefined planar detection zone. On the basis of the information received, the control unit 9 then actuates the operation of the drive system 7 and the vertical movement of the fork 4. The detection device 10 may be, for example, a laser sensor of the Lidar type.

The operating principle of the autonomous forklift truck 1 for detecting the presence or the absence of a load 12 to be set down on a rack 13 will now be described with reference to FIGS. 2 and 3.

In an initial phase, the control unit 9 actuates the operation of the truck 1 in order for it to move towards the rack 13 and to raise the arms of the fork 4 bearing the load to be set down in order to position the latter with respect to the rack 13. The truck 1 is actuated by the control unit 9 on the basis of the data output by the locating device 8. While it is moving, the truck 1 is made to maintain a minimum safety distance d with respect to the rack 13. During the initial phase, the truck 1 is made to maintain a minimum horizontal safety distance between the overhanging end of the arms of the fork 4 and the rack 13 in order to allow the arms of the fork 4 to pass safely above the rack 13.

The control unit 9 can use the information transmitted by the determining means 11 to precisely control the movement of the truck 1 in addition to the data output by the locating device 8.

After this initial phase, the detection device 10 emits a light beam 14 that sweeps over at least one predefined planar detection zone 15a situated above the arms 4a, 4b of the fork. The vertical projection of the detection zone 15 covers the arms 4a, 4b of the fork and the transverse space between these arms.

In the exemplary embodiment illustrated, the detection zone 15a is defined by four distinct points that delimit a rectangle, such as the points B, C, D and E in FIG. 3. The point A schematically represents the emission point of the light beam 14 exiting the device 10. The detection zone 15a is horizontal in this case. Alternatively, it could be possible to provide a zone 15a that is inclined with respect to the horizontal.

The long side of the rectangle delimited by the points B, C, D and E has a length y greater than the transverse space requirement of the arms 4a, 4b of the fork, and the detection zone 15a is centred relative to these arms. In other words, the planar detection zone 15a extends laterally beyond the transverse space requirement of the arms 4a, 4b of the fork. By way of indication, the width w of the short side of the rectangle delimited by the points B, C, D and E, and therefore the depth of the detection zone 15a, may be equal to 50 mm.

The detection device 10 is configured to detect whether the load 12 is located within the detection zone 15a. The load 12 is detected as being present by the device 10 when it intersects the light beam 14 and is located within the first detection zone 15. The detection device 10 is able to detect that the load is located within the first detection zone 15 by way of a distance measurement.

If the light beam 14 emitted by the device 10 does not intersect the load, or if this intersection exists but the detection device 10 detects that the distance separating it from the load 12 is outside the predefined planar detection zone 15, the device 10 detects an absence of the load 12 from said detection zone.

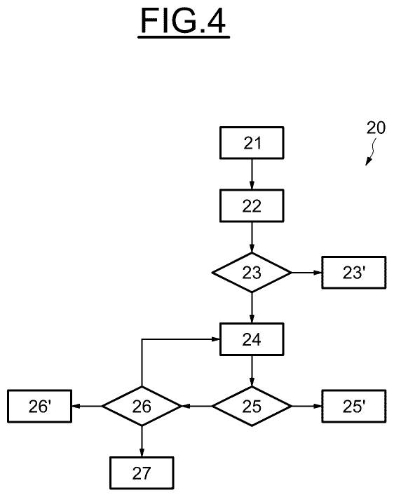

A method 20 for setting down a load using the autonomous forklift truck 1 will now be described. The method 20 is illustrated in FIG. 4.

The method 20 starts with the step 21 of setting down the load 12, during which the control unit 9 steers the truck 1 to a position for setting down the load. Once the truck 1 has reached the position for setting down the load, the control unit 9 steers the movement of the arms 4a, 4b with respect to the rack 13 in order to set the load 12 down thereon. During this phase, the control unit 9 steers the lowering of the load 12 above the rack 13 until the load 12 is brought into contact with the part of the rack 13 that is intended to receive the load 12. The control unit 9 then continues to lower the arms 4a, 4b, bringing about a relative vertical movement between the arms 4a, 4b and the load 12, meaning that the latter is no longer in contact with the arms 4a, 4b and is resting entirely on the rack 13.

The method 20 continues with a step 22 of recording the position of the forklift truck 1 in the position for setting down the load as a reference position.

During the following load detection step 23, the device 10 detects whether the load 12 is absent from the predefined planar detection zone 15a (FIG. 3).

If the presence of the load in the zone 15a is detected, the control unit 9 stops the truck 1 in step 23′ in order to allow reordering by an operator.

If the absence of the load from the zone 15a is detected, the method continues with a reversing step 24. During this step 24, the control unit 9 steers the truck 1 to reverse it by a predetermined reversing distance away from the rack 13 and from the load 12. The reversing distance has a predefined value, and may, for example, be equal to 50 mm. The control unit 9 controls the reversing of the truck 1 via the information output by the determining means 11.

In a variant, the method 20 could comprise an additional reversing step carried out before the detection step 23.

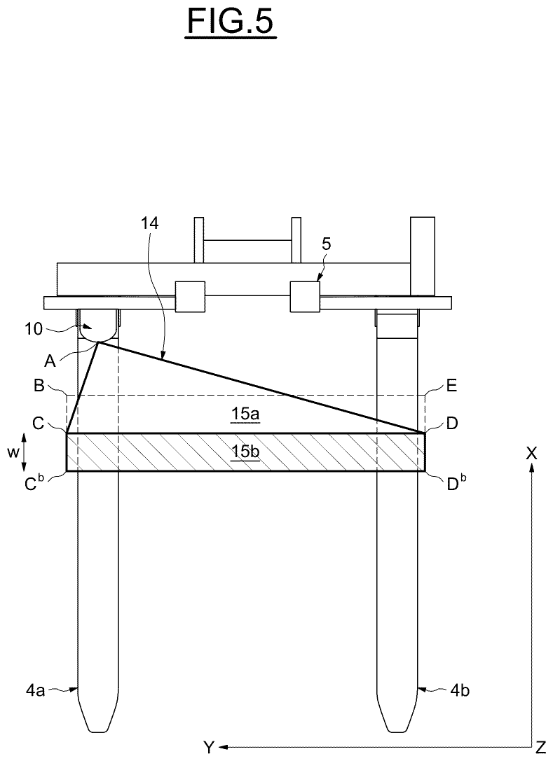

Following the step 24 of reversing the forklift truck 1 by the predetermined reversing distance, the method continues with a load detection step 25 in which the device 10 carries out load detection in a new predefined planar detection zone 15b (FIG. 5) which is contiguous with the preceding planar detection zone 15a with regard to the axis of elongation of the arms 4a, 4b of the fork. The predefined planar detection zone 15b is situated on the opposite side to the detection device 10 with respect to the preceding planar detection zone 15a and has a lateral dimension w equal to the value of reversing the forklift truck 1 carried out in the reversing step 24. In FIG. 5, the predefined planar detection zone 15b corresponds to the rectangle CC^{b}D^{b}D. Given the contiguous nature of the zone 15b with respect to the zone 15a, the rectangles BCDE and CC^{b}D^{b}D share one of their long sides, namely the side CD.

If the presence of the load in the zone 15b is detected in step 25, the control unit 9 stops the truck 1 in step 25′ in order to allow reordering by an operator.

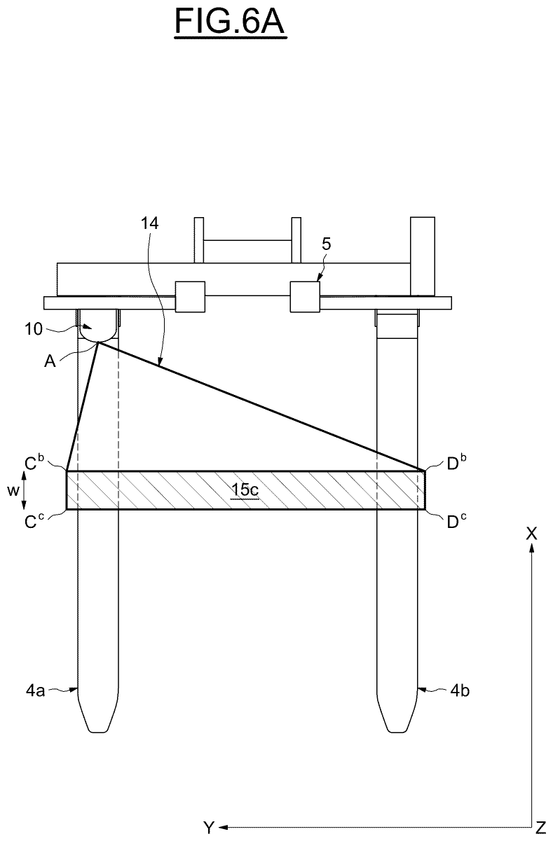

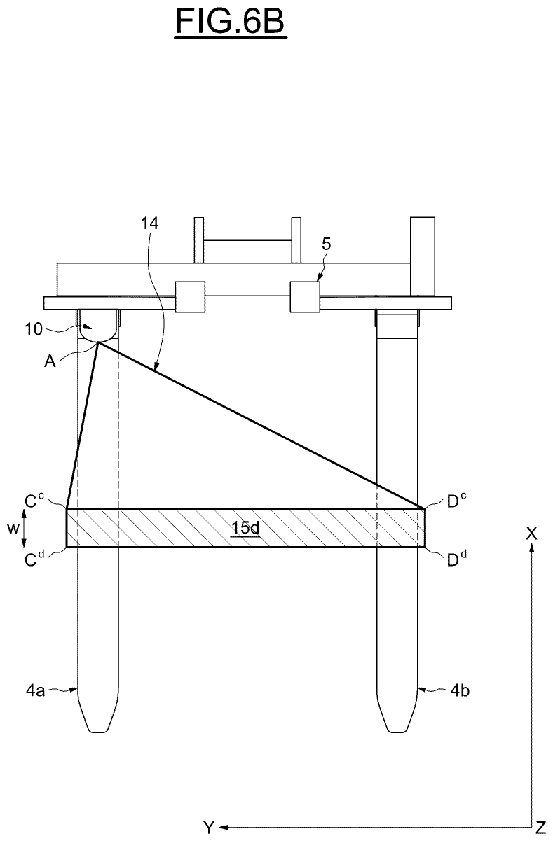

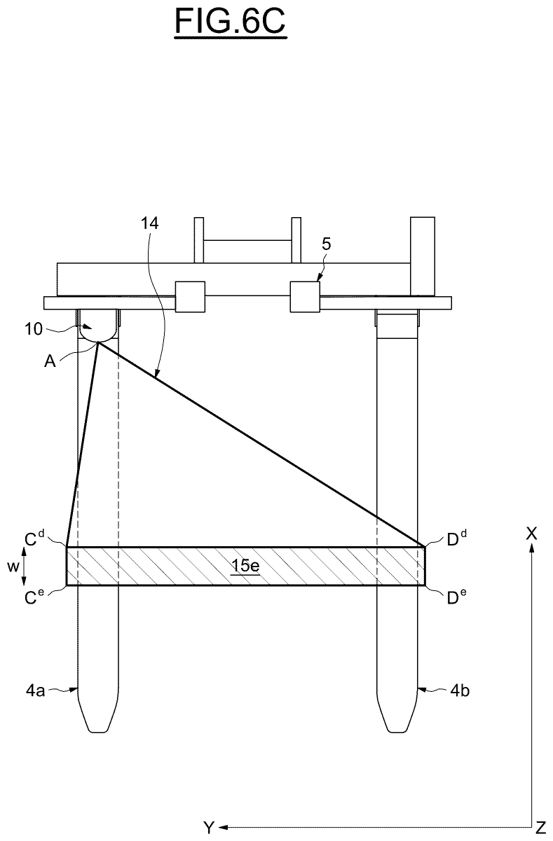

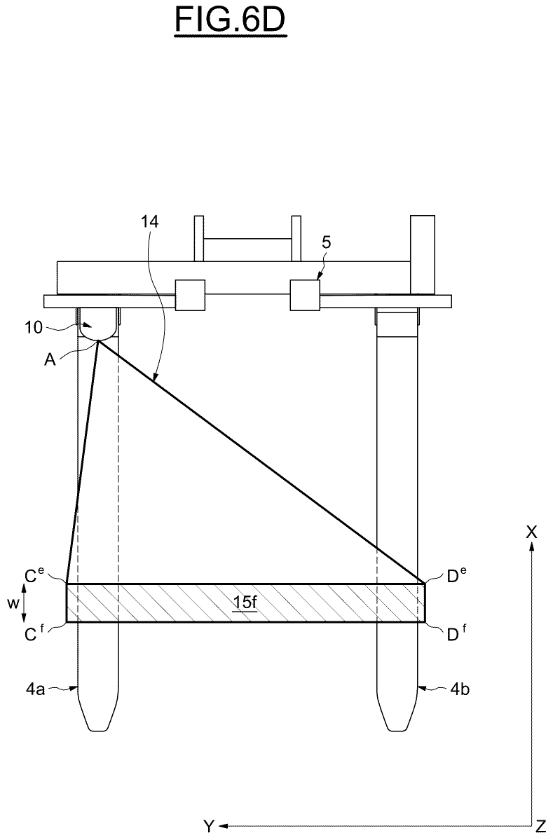

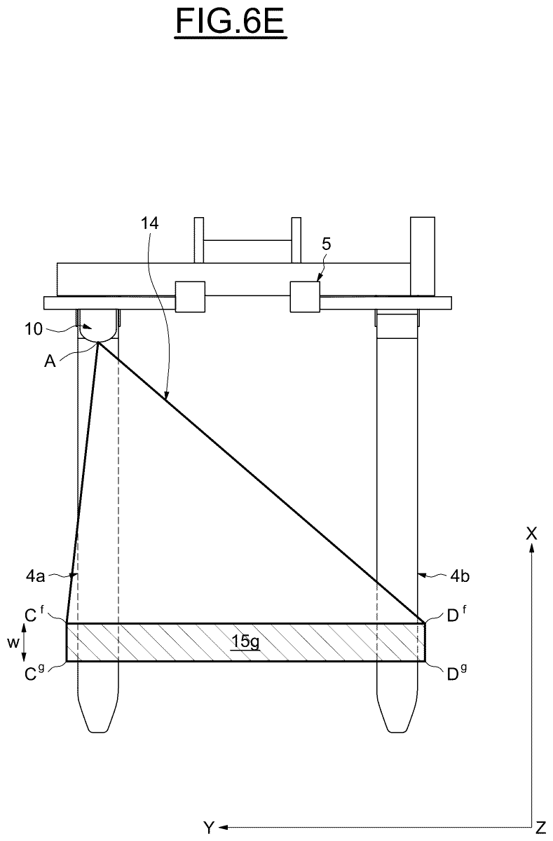

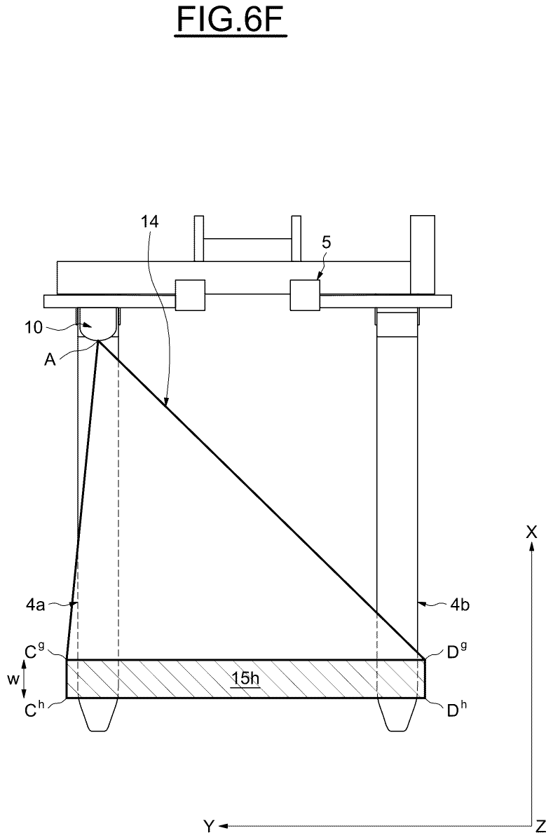

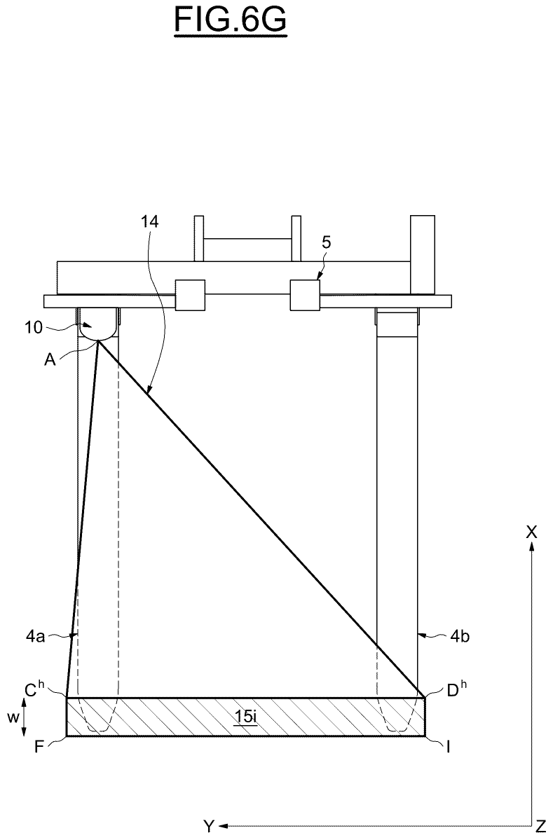

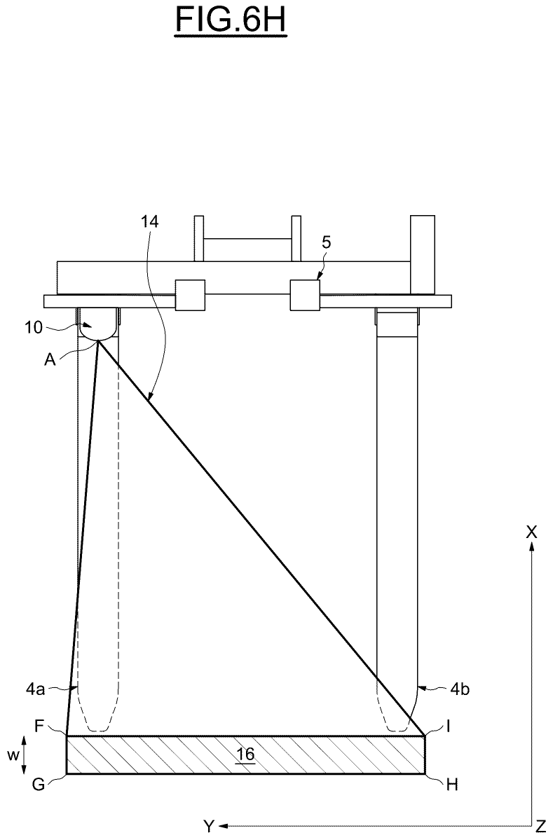

If the absence of the load from the zone 15b is detected in the load detection step 25, the method 20 continues with repeating 26 the reversing step 24 and the detection step 25 until the detection device 10 detects a load in a predefined planar clearance zone 16 (FIG. 6H) with respect to the free end of the arms 4a, 4b of the fork.

In the exemplary embodiment illustrated, the clearance zone 16 corresponds to a predetermined zone that is situated in front of the arms 4a, 4b of the fork and which is defined as being a clearance position of the fork with respect to the load 12, in which there is no risk of interference. In FIG. 6H, the clearance zone 16 is defined by four points F, G, H, I that define a rectangle situated in front of the arms 4a, 4b of the fork.

In a variant, it could be possible to define another clearance zone 16 with respect to the free end of the arms 4a, 4b of the fork, for example a zone which is farther away from the free end of the arms 4a, 4b of the fork, or a zone having a different width w.

As indicated above, if the absence of a load from the zone 15b is detected in the load detection step 25, the method 20 continues by repeating the reversing and detection steps.

Thus, following a new reversal of the truck 1 steered by the control unit 9 by a reversing distance with a value equal to that in step 24, a new detection step is carried out in a new predefined planar detection zone 15c (FIG. 6A) contiguous with the preceding planar detection zone 15b. The predefined planar detection zone 15c is situated on the opposite side to the detection device 10 with respect to the preceding planar detection zone 15b and has a lateral dimension w equal to the value of reversing the forklift truck 1 that has just been carried out.

If the presence of the load in the zone 15c is detected, the control unit 9 stops the truck 1 in order to allow reordering by an operator. If the absence of the load from the zone 15c is detected, the method 20 continues.

The repetition of the reversing and detection steps continues in an identical manner with detection zones 15d (FIG. 6B) to 15i (FIG. 6G), as far as the planar clearance zone 16 (FIG. 6H).

The steps of reversing the forklift truck 1 are carried out continuously without stopping. The detection zones 15a to 15i and the clearance zone 16 are activated by the detection device 10 successively according to the constant reversing value of the forklift truck.

If the load is absent from the clearance zone 16 when the load detection is carried out in this zone 16, the method passes to the step 27 of moving the forklift truck 1, which can then be allocated to a different task.

On the other hand, if the load is present in the clearance zone 16 during this detection, the control unit 9 stops the truck 1 in step 26′ in order to allow reordering by an operator.

In another embodiment, it could be possible for the method to pass to step 27 if the load is present in the clearance zone 16 when the load detection is carried out in this zone 16. With such an embodiment, it is preferable to provide a greater spacing between the free end of the arms 4a, 4b of the fork and the zone 16.

In the embodiment described, the method 20 comprises a step of load detection in the clearance zone 16 which is situated in front of the arms 4a, 4b of the fork. As indicated above, it could be possible to define another clearance zone 16.

For example, the clearance zone 16 could be defined as being behind the free end of the arms 4a, 4b of the fork. In this case, the vertical projection of the clearance zone 16 is situated on the arms 4a, 4b of the fork.

With a clearance zone 16 defined in this way, the method passes to the step 27 of moving the forklift truck if the load is absent from this zone 16 and if the sum of the values of reversing the forklift truck carried out from the setting down position is greater than the distance between the free end of the arms 4a, 4b of the fork and the long side BE of the rectangle of the detection zone 15a.

In the embodiment described, a single step of recording, i.e. a step of referencing, the position of the forklift truck in the position for setting down the load as a reference position is provided. In a variant, it is also possible to provide a step of referencing the position of the forklift truck after each reversal by the predetermined reversing distance.

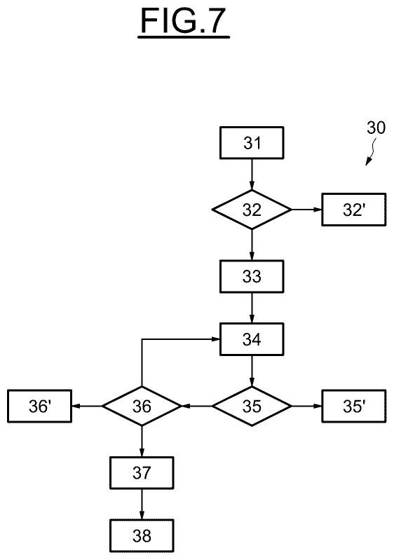

A method 30 for lifting and transporting a load using the autonomous forklift truck 1 will now be described. The method 30 is illustrated in FIG. 7.

The method 30 starts with the positioning step 31, during which the control unit 9 steers the truck 1 to position the arms 4a, 4b with respect to the rack 13 in a position for picking up the load 12. Before and during this step, the load 12 rests on the rack.

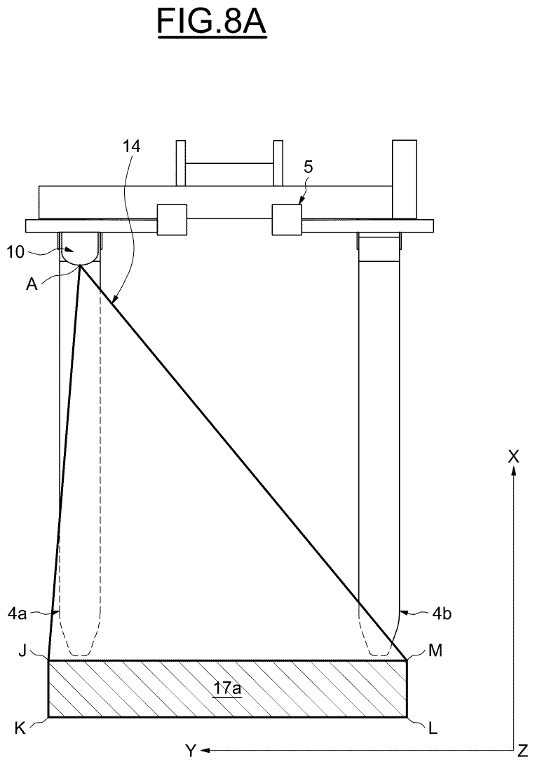

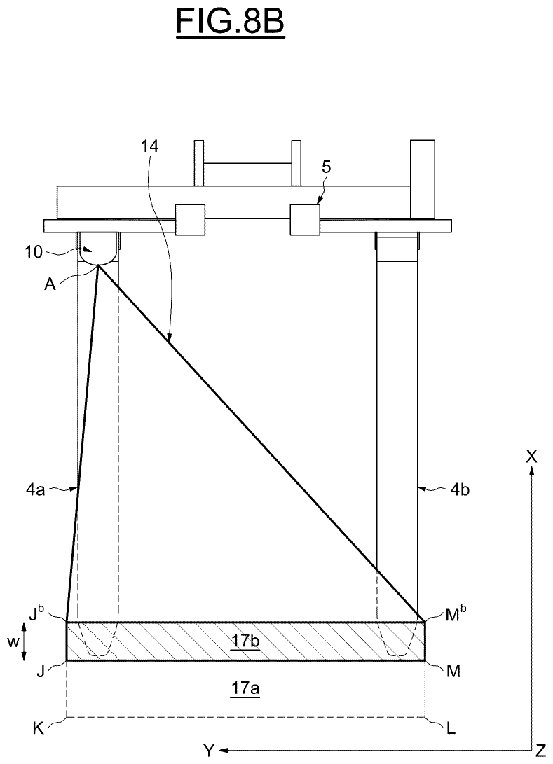

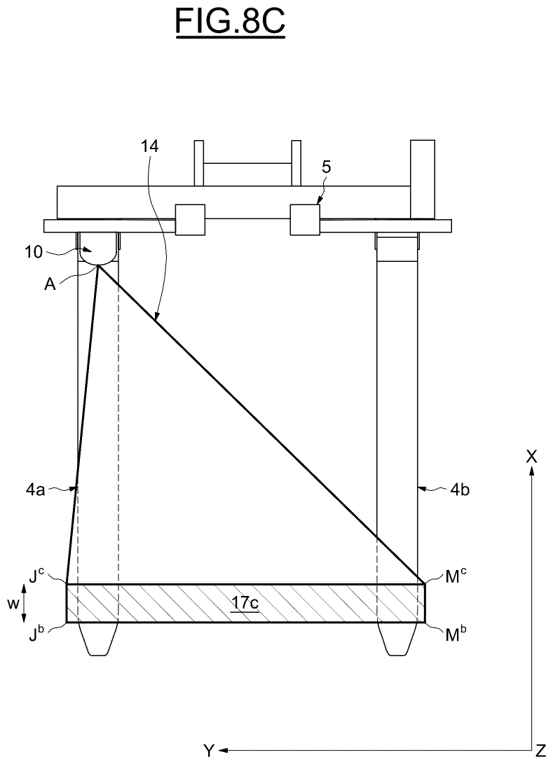

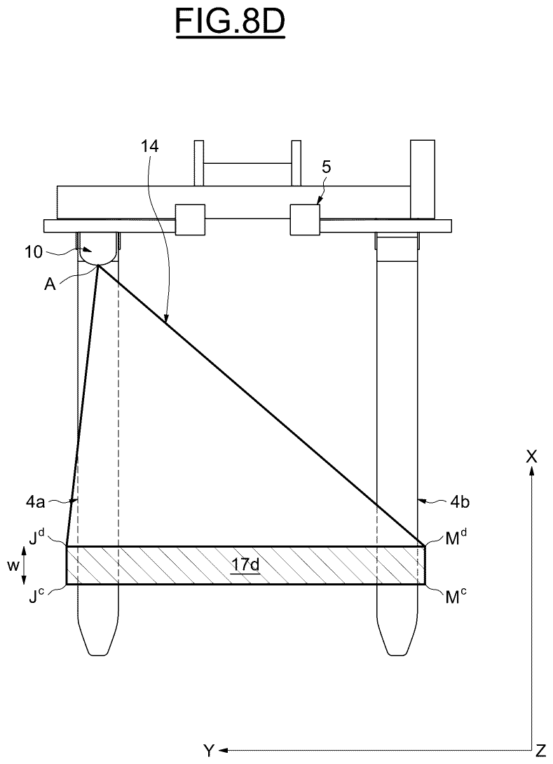

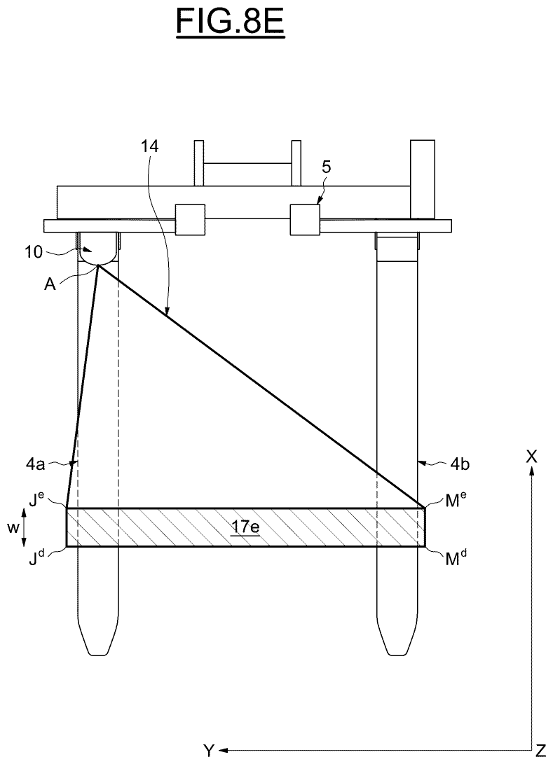

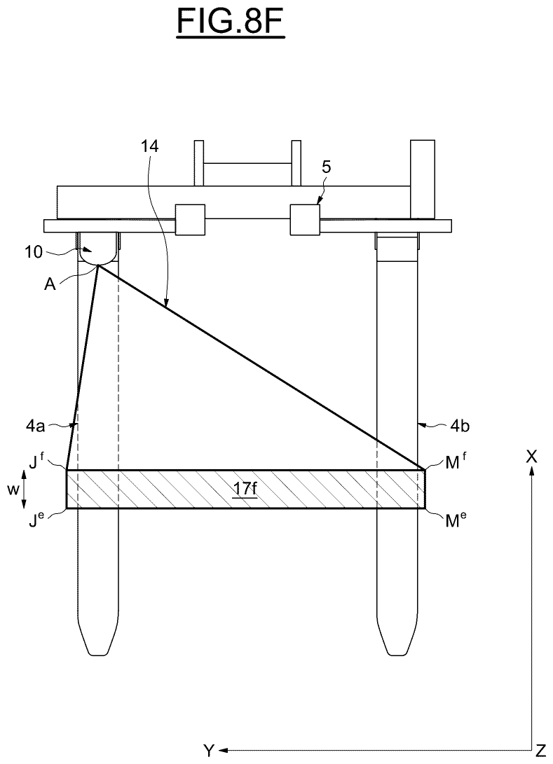

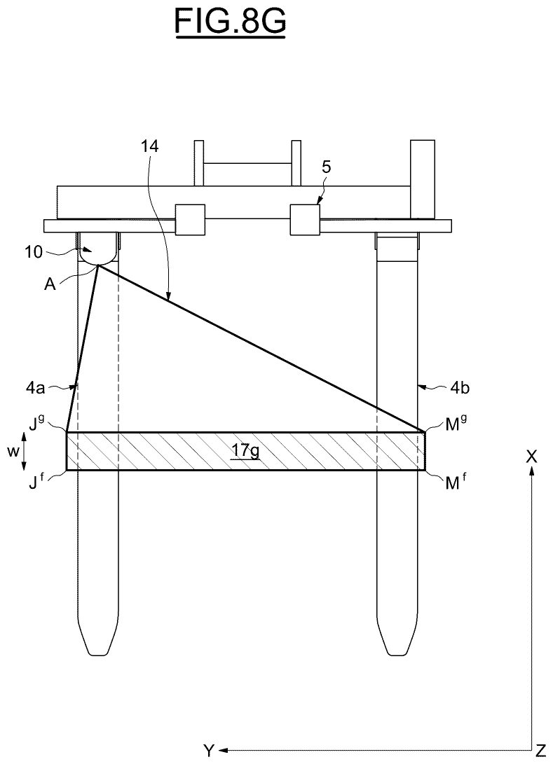

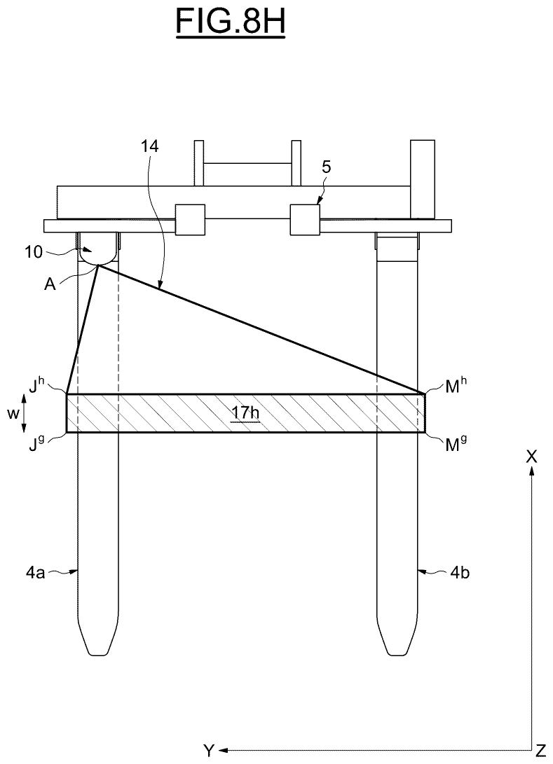

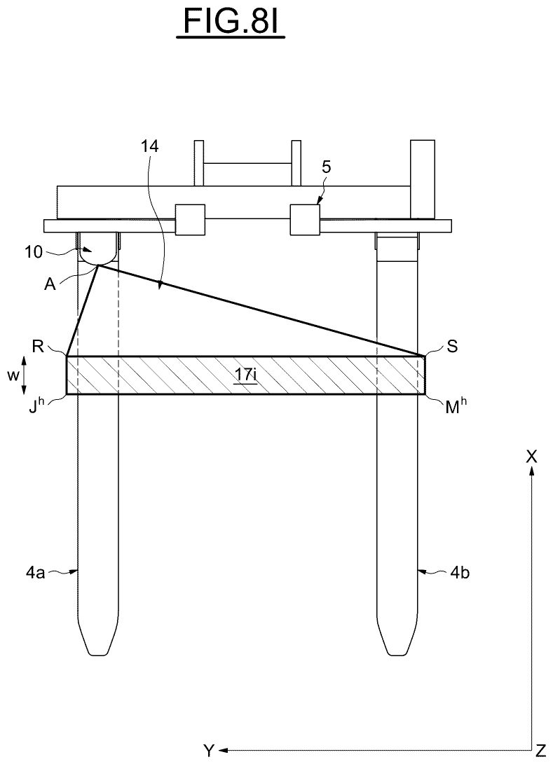

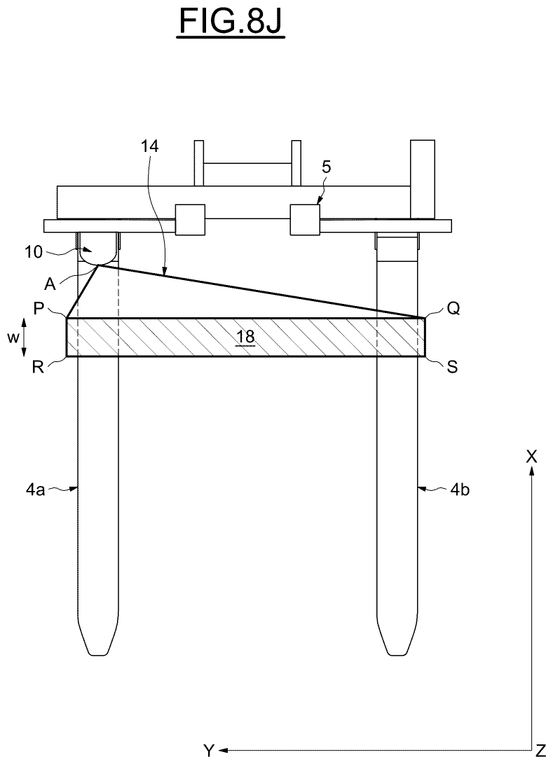

The method 30 continues with a step 32 of load detection by the detection device 10 in a predefined planar detection zone 17a (FIG. 8A). In the exemplary embodiment illustrated, the zone 17a corresponds to a predetermined zone which is situated in front of the arms 4a, 4b of the fork. In FIG. 8A, the zone 17a is defined by four points J, K, L and M that delimit a rectangle situated in front of the arms 4a, 4b of the fork.

If the presence of a load in the planar detection zone 17a is not detected, the control unit 9 stops the truck 1 in step 32′ in order to allow reordering by an operator.

If the presence of a load in the zone 17a is detected, the method 30 continues with a step 33 of recording the position of the forklift truck 1 in the position for detecting the load 12 as a reference position, followed by an advancing step 34.

During the advancing step 34, the control unit 9 steers the truck 1 to advance it by a predetermined advancing distance towards the rack and the load. This advancing has a predefined value, and may, for example, be equal to 50 mm. The control unit 9 controls the advancing of the truck 1 via the information output by the determining means 11.

In a variant, the method 30 could comprise an additional advancing step carried out before the referencing step 33.

Following the step 34 of advancing the forklift truck 1 by the predetermined reversing distance, the method 30 continues with a load detection step 35 in which the detection device 10 carries out load detection in a new predefined planar detection zone 17b (FIG. 8B) which is contiguous with the preceding planar detection zone 17a with regard to the axis of elongation of the arms 4s, 4b of the fork. The predefined planar detection zone 17b is situated next to the detection device 10 with respect to the preceding planar detection zone 17a and has a lateral dimension w equal to the value of advancing of the forklift truck 1 carried out in the advancing step 34. In FIG. 8B, the predefined planar detection zone 17b corresponds to the rectangle J^{b}JMM^{b}. Given the contiguous nature of the zone 17b with respect to the zone 17a, the rectangles J^{b}JMM^{b} and JKLM share one of their long sides, namely the side JM.

If the absence of the load from the zone 17b is detected, the control unit 9 stops the truck 1 in step 35′ in order to allow reordering by an operator.

If the presence of the load in the zone 17b is detected, the method 30 continues with repeating 36 the advancing step 34 and the detection step 35 until the detection device 10 detects a load in a predefined planar pick-up zone 18 with respect to the vertical uprights of the fork which is illustrated in FIG. 8J.

In the exemplary embodiment illustrated, the pick-up zone 18 corresponds to a predetermined zone that is situated next to the vertical uprights of the fork and which is defined as being a safety position for picking up a load. In FIG. 8J, the pick-up zone 18 is defined by four points P, R, S and Q that define a rectangle situated next to the vertical uprights of the fork.

As indicated above, if the presence of the load in the zone 17b is detected in the load detection step 35, the method 30 continues by repeating the advancing and detection steps.

Thus, following a new advancing of the truck 1 steered by the control unit 9 by an advancing distance with a value equal to that in step 34, a new detection step is carried out in a new predefined planar detection zone 17c (FIG. 8C) which is contiguous with the preceding planar detection zone 17b. The predefined planar detection zone 17c is situated next to the detection device 10 with respect to the preceding planar detection zone 17b and has a lateral dimension w equal to the value of advancing the forklift truck 1 that has just been carried out.

If the absence of the load from the zone 17c is detected, the control unit 9 stops the truck 1 in order to allow reordering by an operator. If the presence of the load in the zone 17c is detected, the method 30 continues.

The repetition of the advancing and detection steps continues in an identical manner with zones 17d (FIG. 8D) to 17i (FIG. 8I), as far as the pick-up zone 18 as shown in FIG. 8J.

The steps of advancing the forklift truck 1 are carried out continuously without stopping. The detection zones 17a to 17i and the pick-up zone 18 are activated by the detection device 10 successively according to the constant advancing value of the forklift truck.

If the load is absent from the pick-up zone 18 when the load detection is carried out in this zone 18, the control unit 9 stops the truck 1 in step 36′ in order to allow reordering by an operator.

On the other hand, if the load is present in the pick-up zone 18 during this detection, the method passes to the step 37 in which the control unit 9 effects the lifting of the load by emitting a lifting instruction.

After the load 12 has been lifted, the method 30 continues with the step 38 of moving the forklift truck and transporting the load 12.

In the embodiment described, a single step of recording, i.e. a step of referencing, the position of the forklift truck in the position for detecting the load as a reference position is provided. In a variant, it is also possible to provide a step of referencing the position of the forklift truck after each advancing by the predetermined advancing distance.

In each of the embodiments described, the detection steps are carried out with detection zones of the detection device that are each common to the arms 4a and 4b of the fork.

In a variant, it could be possible to provide, in each detection step and for each of the arms 4a, 4b of the fork, a detection zone which belongs thereto. In this case, in each detection step, the detection device emits a light beam that sweeps over a detection zone that belongs to the arm 4a of the fork and is situated above this arm 4a, and a zone that belongs to the arm 4b, is situated above this arm 4b and is separate from the detection zone that belongs to the arm 4a.

1.-17. (canceled)

18. An autonomous forklift truck comprising:
a vertically movable fork that is provided with at least two arms for lifting loads;
a drive system for moving the forklift truck;
a control unit that is able to actuate operation of the drive system in order to autonomously guide the forklift truck, and that is able to actuate vertical movement of the vertically movable fork;
a contactless load detection device, the contactless load detection device being movable together with the vertically movable fork and being disposed above the at least two arms of the vertically movable fork, the contactless load detection device being able to emit a light beam that sweeps over at least one predefined planar detection zone situated above the at least two arms in order to detect the presence or the absence of a load; and
determining means for determining a movement of the forklift truck, the determining means being able to acquire information representative of the movement of the forklift truck from a position, saved by the control unit, of the forklift truck in which it is setting down or picking up a load,
wherein the control unit receives information representative of the movement of the forklift truck that is output by the determining means and information representative of a presence or absence of the load in the predefined planar detection zone that is output by the contactless load detection device and is able to actuate the operation of the drive system and the vertical movement of the vertically movable fork on a basis of the information.

19. The autonomous forklift truck according to claim 18, wherein the determining means comprises at least one rotary encoder that is able to measure rotation of at least one wheel of the forklift truck.

20. The autonomous forklift truck according to claim 18, wherein the predefined planar detection zone that is swept by the light beam emitted by the contactless load detection device is horizontal.

21. The autonomous forklift truck according to claim 18, wherein the vertically movable fork comprises at least two uprights supporting the at least two arms, the contactless load detection device being disposed on one of the uprights.

22. The autonomous forklift truck according to claim 18, further comprising an onboard locating device configured to acquire forklift-truck position data and communicate with the control unit, the contactless load detection device being separate from the onboard locating device.

23. The autonomous forklift truck according to claim 22, wherein the determining means is separate from the onboard locating device.

24. A method for transporting and setting down a load using the autonomous forklift truck according to claim 18, the method comprising:
a step of setting down the load, in which the forklift truck has reached a position for setting down the load;
a step of recording the position of the forklift truck in the position for setting down the load as a reference position;
a step of load detection by the contactless load detection device in at least one predefined planar detection zone;
if the load is not detected in the detection step, a step of reversing the forklift truck by a predetermined reversing distance which is controlled via the information output by the determining means;
following the step of reversing the forklift truck by the predetermined reversing distance, a step of load detection by the contactless load detection device in at least one predefined planar detection zone which is contiguous with the preceding planar detection zone, which is situated on an opposite side to the contactless load detection device with respect to the preceding planar detection zone, and which has a lateral dimension equal to a value of reversing the forklift truck carried out in the reversing step;
if the load is not detected in the immediately preceding detection step, repeating the reversing step and the detection step until a load is detected in at least one predefined planar clearance zone with respect to a free end of the at least two arms of the fork; and
a step of moving the forklift truck, which is triggered at least on a basis of the presence or absence of a load in the predefined planar clearance zone.

25. The method according to claim 24, wherein the predefined planar clearance zone is situated in front of the free end of the at least two arms of the vertically movable fork.

26. The method according to claim 24, wherein the predefined planar clearance zone is situated behind the free end of the at least two arms of the vertically movable fork, and the step of moving the forklift truck is triggered if the absence of a load in the predefined planar clearance zone is detected and if a sum of values of reversing the forklift truck carried out from the setting down position is greater than a distance between the free end of the at least two arms of the vertically movable fork and a part of the at least one predefined planar detection zone in the step of load detection which is situated next to the contactless load detection device.

27. The method according to claim 24, wherein the reversing of the forklift truck that is carried out during the reversing steps has a constant value.

28. The method according to claim 27, wherein the steps of reversing the forklift truck are carried out continuously without stopping, the at least one predefined planar detection zone and the at least one predefined planar detection zone which is contiguous with the preceding planar detection zone and the at least one predefined planar clearance zone being activated by the contactless load detection device successively according to the constant reversing value of the forklift truck.

29. A method for lifting and transporting a load using the autonomous forklift truck according to claim 18, the method comprising:
a step of positioning the at least two arms of the vertically movable fork with respect to the load to be lifted in a position for picking up the load;
a step of detecting a presence of a load using the contactless load detection device in at least one predefined planar detection zone with respect to a free end of the at least two arms of the vertically movable fork;
if the load is detected in the detection step, a step of recording a position of the forklift truck in the position for detecting the load as a reference position;
a step of advancing the forklift truck by a predetermined advancing distance which is controlled via the information output by the determining means;
following the step of advancing the forklift truck by the predetermined advancing distance, a step of detecting the load using the contactless load detection device in at least one predefined planar detection zone which is contiguous with the preceding planar detection zone, which is situated next to the contactless load detection device with respect to the preceding planar detection zone, and which has a lateral dimension equal to a value of advancing the forklift truck carried out in the advancing step;
if the load is detected in the preceding detection step, repeating the advancing step and the detection step until a load is detected in at least one predefined planar pick-up zone;
a step of lifting the load if the load is detected in the at least one predefined planar pick-up zone; and
after the lifting step, a step of moving the forklift truck and transporting the load.

30. The method according to claim 29, wherein the advancing of the forklift truck that is carried out during the advancing steps has a constant value.

31. The method according to claim 30, wherein the steps of advancing the forklift truck are carried out continuously without stopping, the predefined planar detection zones and the at least one predefined planar pick-up zone being activated by the contactless load detection device successively according to the constant advancing value of the forklift truck.

32. The method according to claim 24, wherein each predefined planar detection zone is defined by four points that delimit a rectangle.

33. The method according to claim 24, wherein the step of detecting the load is carried out in a planar detection zone which is common to the at least two arms of the vertically movable fork.

34. The method according to claim 24, wherein the step of detecting the load is carried out in two planar detection zones which each belong to one of the at least two arms of the vertically movable fork.
